(19) United States
(12) Patent Application Publication
(10) Pub. No.: US 2022/0097574 A1
(43) Pub. Date: Mar. 31, 2022

(54) ROTATING VEHICLE SEAT AND A METHOD FOR ROTATING A ROTATING VEHICLE SEAT

(71) Applicant: Ningbo Geely Automobile Research & Development Co., Ltd., Ningbo (CN)

(72) Inventors: Oskar EWEHAG, Goteborg (SE); Johan HÖCKS, Varberg (SE); Christian FORSBERG, Laholm (SE)

(21) Appl. No.: 17/549,174

(22) Filed: Dec. 13, 2021

Related U.S. Application Data
(63) Continuation of application No. PCT/CN2020/094187, filed on Jun. 3, 2020.

(30) Foreign Application Priority Data
Jun. 27, 2019 (EP) 19183037.1

(51) Int. Cl. B60N 2/14; B60N 2/50; B60N 2/02

(52) U.S. Cl. CPC B60N 2/143; B60N 2/146; B60N 2002/0236; B60N 2/0232; B60N 2/50

(57) ABSTRACT

A rotating vehicle seat includes a backrest attached to a seat base frame and arranged to be rotatably adjustable around a first horizontal axis, a seat base attached to the frame and arranged to be rotatably adjustable around a second horizontal axis parallel to the first horizontal axis, a gear mechanism connected to the frame arranged to rotate the frame from a forward facing position to a backward facing position, wherein the gear mechanism comprises a track, and the frame comprises a guide that is configured to engage the track, such that when the gear mechanism is actuated, the frame is translated in a xy-plane and is rotated around a first vertical axis, and wherein the backrest and the seat base, respectively, are arranged to be folded upwards during at least part of the rotation of the frame around the first vertical axis.

RELATED APPLICATION DATA

This application is a continuation of International Patent Application No. PCT/CN2020/094187, filed Jun. 3, 2020, which claims the benefit of European Patent Application No. 19183037.1, filed Jun. 27, 2019, the disclosures of which are incorporated herein by reference in their entireties.

### TECHNICAL FIELD

The present invention relates to a rotating vehicle seat and a method for rotating a rotating vehicle seat. More specifically, the disclosure relates to a rotating vehicle seat and a method for rotating a rotating vehicle seat as defined in the introductory parts of claim 1 and claim 10.

### BACKGROUND

Vehicle seats in most vehicles are fixedly attached facing forward in the driving direction of the vehicle. This comes natural as the driver always needs to be facing forward. However, seats in the vehicle that are not driver seats do not necessarily need to be facing forward. In self-driving vehicles, the seats can also be directed in any direction. As it is still preferred in many situations to have seats directed in the driving direction while driving, while in other situations having seats facing other directions, rotating seats have been used in some vehicles.

Rotating vehicles does, however require a lot of space as vehicle seats often are large chairs. Vehicle seats also often have a seat base or backrest that protrudes longer from the base frame of the seat, which further increases the oration diameter that needs to be free if the seat is to be rotated. As vehicles have limited space, fixedly attached seats are often chosen instead of rotating seats, limiting the usability of the vehicle.

There is thus a need in the industry for improved vehicle seats that can be set in different facing angles without requiring a large free rotation volume inside the vehicle cabin space.

### SUMMARY

It is an object to mitigate, alleviate or eliminate one or more of the above-identified deficiencies in the art and disadvantages singly or in any combination and solve at least the above mentioned problem. According to a first aspect there is provided a rotating vehicle seat comprising a backrest attached to a seat base frame and arranged to be rotatably adjustable around a first horizontal axis, a seat base attached to the seat base frame and arranged to be rotatably adjustable around a second horizontal axis parallel to the first horizontal axis, a gear mechanism connected to the seat base frame arranged to rotate the seat base frame from a forward facing position to a backward facing position, wherein the gear mechanism comprises a track, and the seat base frame comprises a guide that is configured to engage the track, such that when the gear mechanism is actuated, the seat base frame is translated in a XY-plane and is rotated around a first vertical axis, and wherein the backrest and the seat base, respectively, are arranged to be folded upwards during at least part of the rotation of the seat base frame around the first vertical axis.

By both translating the seat base frame in the horizontal plane, the XY-plane, while at the same time fold the seat base and the backrest upwards, the space available for rotating the vehicle seat can be used optimally. The translation path of the seat base frame and rotation at each point along the path is chosen in line with available space in the vehicle. The rotational volume required for the rotation of the vehicle seat is minimized and the tailored translation path may further reduce the space needed.

According to some embodiments, the backrest and the seat base are arranged to be folded upwards to a substantially vertical position during at least part of the rotation around the first vertical axis.

In that way the rotational volume and the top view space of the vehicle seat is minimized. If a vertical position of either of the seat base or the backrest is not possible due to bolster design or similar, the seat base and backrest are folded as close to vertical position as possible.

According to some embodiments, the backrest and the seat base are arranged to be folded upwards during at least part of the rotation around the first vertical axis to a position so as to be positioned within a cylindrical rotation volume along the first vertical axis with a circular cross section, the diameter of the circular cross-section being defined by the width of the seat base and/or the width of the backrest. The folding angle of the backrest and seat base is thus adjusted by the available space.

According to some embodiments, the gear mechanism comprises a track and the seat base comprises a guide configured to run in the track such that when the gear mechanism is actuated, the seat base frame translates in a horizontal XY-plane before, after and/or during rotation of the seat base frame around the first vertical axis. The timing of the translation relative the rotation is chosen to make use of the available space and makes it possible to rotate a seat in a space smaller than the minimal rotational volume defined by the width of the seat base and the backrest.

According to some embodiments, the track comprises: a first translation track part extending in a an X-direction in the horizontal plane perpendicular to a forward direction of the vehicle seat, a second translation track part extending in a an X-direction perpendicular to a forward direction of the vehicle seat, and an elliptical track part connecting the first translation track part and the second translation track part. This may be especially advantageous in case of a vehicle seat where the seat base cannot be folded upwards. The backrest is then moved towards the side inner wall of the vehicle during rotation to require less space during rotation.

According to some embodiments, the gear mechanism comprises an cylinder gear mounted on the vehicle floor, a motor driving the cylinder gear and a an elongated toothed engagement part mounted on the seat base frame extending linearly in a side direction of the vehicle seat, the elongated toothed engagement part being in engagement with the cylinder gear. This is a more detailed embodiment translation of the set with its backrest up against the inner side wall of the vehicle cabin during rotation of the vehicles seat with a protruding seat base not possible to fold upwards enough.

According to some embodiments, the gear mechanism comprises an elliptical internal ring gear that is affixed to a vehicle body, and a cylinder gear that is affixed to the seat base frame, wherein the cylinder gear is arranged inside the elliptical internal ring gear such that rotation of the cylinder gear causes it to travel along the circumference of the elliptical internal ring gear, and the seat base frame travels along both X- and Y-directions in the horizontal plane during its rotation from forward facing to backward facing, and ends in the same XY-position after having been rotated. This is a different embodiment of achieving translation during rotation so that the backrest moves towards the inner side wall of the vehicle cabin during rotation to allow more room for the seat base.

According to some embodiments, the gear mechanism comprises an internal semicircle gear that is affixed to a vehicle body, and a cylinder gear that is affixed to the seat base frame, wherein the cylinder gear is arranged inside the internal semicircle gear such that rotation of the cylinder gear causes it to travel along the circumference of the internal semicircle gear, and the seat base frame travels along both X and Y-directions in the horizontal plane during its rotation from forward facing to backward facing, and ends in a different XY-position after having been rotated. This a still further embodiment of achieving translation during rotation so that the backrest moves towards the inner side wall of the vehicle cabin during rotation to allow more room for the seat base.

According to some embodiments, the vehicle seat is translated in the XY-plane so that the center of the cylindrical rotation volume is placed on the first vertical axis, i.e. the first vertical axis is in the center point of the cylindrical rotation volume as seen from a top view, so as to minimize the rotational volume.

According to a second aspect there is provided a method for rotating a rotating vehicle seat according to the first aspect, the method comprising the steps of translating the vehicle seat in the XY-plane, rotating the vehicle seat, folding seat base upwards during the rotation of the seat base frame around the first vertical axis.

According to some embodiments, the method comprises the step of folding the backrest upwards during the rotation of the seat base frame around the first vertical axis.

According to some embodiments, the step of translating the seat bas frame of the vehicle seat in the XY-plane is made concurrent with the step of rotating the seat base frame.

Effects and features of the second aspect are to a large extent analogous to those described above in connection with the first aspect. Embodiments mentioned in relation to the first aspect are largely compatible with the second aspect.

A further scope of applicability of the present invention will become apparent from the detailed description given below. However, it should be understood that the detailed description and specific examples, while indicating preferred embodiments of the invention, are given by way of illustration only. Various changes and modifications within the scope of the invention will become apparent to those skilled in the art from the detailed description.

Hence, it is to be understood that the herein disclosed invention is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTION OF THE DRAWINGS

The above objects, as well as additional objects, features and advantages of the present invention, will be more fully appreciated by reference to the following illustrative and non-limiting detailed description of example embodiments of the present invention, when taken in conjunction with the accompanying drawings.

FIG. 1A shows a perspective view of a vehicle seat according to an embodiment of the present disclosure where the seat base frame is attached to a cylindrical gear rotating in an elliptical internal ring gear.

FIG. 1B is a perspective view of the vehicle seat of FIG. 1 after the vehicle seat has been rotated 180 degrees.

FIG. 2A is a perspective view of a gear mechanism for a vehicle seat according to one embodiment of the invention.

FIG. 2B is a perspective view of the gear mechanism shown in FIG. 2A where the seat base frame has been translated and rotated about 50 degrees.

FIG. 2C is a perspective view of the gear mechanism shown in FIG. 2A where the seat base frame has been rotated 180 degrees.

FIG. 3A is a perspective view of a vehicle seat according to an embodiment of the present disclosure where the seat base frame is attached to a cylindrical gear rotating in a semi-elliptical internal ring gear

FIG. 3B is a perspective view of the vehicle seat in FIG. 3A rotated 180 degrees.

FIGS. 4A is a perspective view of a vehicle seat according to an embodiment of the present disclosure where the seat base and the back rest is in a position ready for use by a user.

FIG. 4B is a perspective view of the vehicle seat in FIG. 4A where the backrest and seat base have been folded upwards.

FIG. 4C is a perspective view of the vehicle seat in FIG. 4A where the backrest and seat base have been folded upwards and the seat base frame has been rotated slightly.

FIG. 4D is a perspective view of the vehicle seat in FIG. 4A where the backrest and seat base have been folded upwards and the seat base frame has been rotated almost 180 degrees.

FIG. 4E is a perspective view of the vehicle seat in FIG. 4A where the backrest and seat base have been rotated 180 degrees and the seat base and backrest are folded down ready to be used by a user.

FIG. 4F is a perspective view of the vehicle seat in FIGS. 4A-4E showing the rotational volume used when the backrest and seat base are folded up in relation to the volume of the vehicle seat when the backrest and the seat base are folded down.

FIG. 5 is a block chart of representing the method according to the invention.

### DETAILED DESCRIPTION

The present invention will now be described with reference to the accompanying drawings, in which currently preferred example embodiments of the invention are shown. This invention may, however, be embodied in many different forms and should not be construed as limited to the herein disclosed embodiments. The disclosed embodiments are provided to fully convey the scope of the invention to the skilled person.

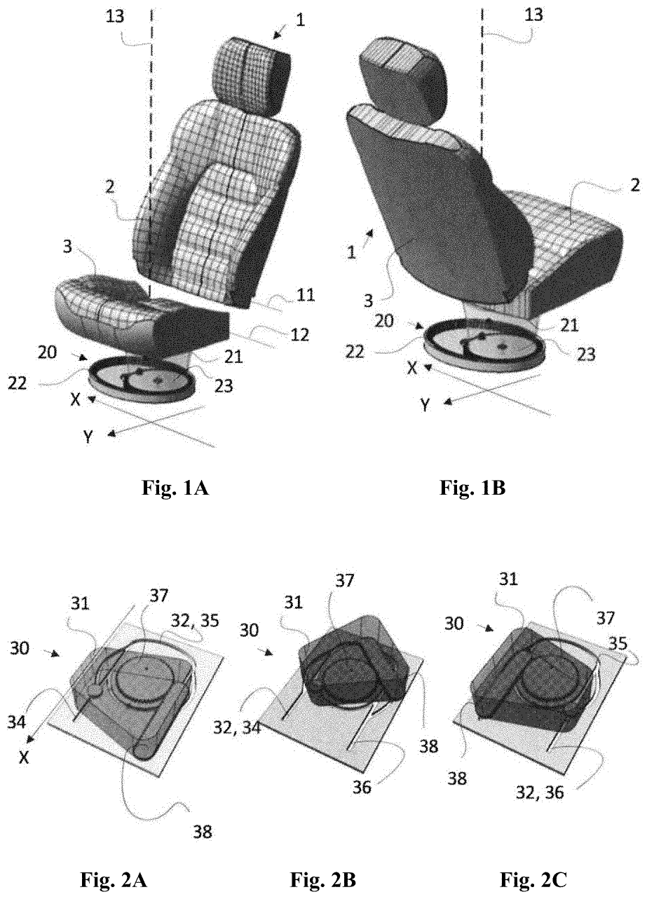

FIGS. 1 through 4F show the first aspect of this disclosure shows a rotating vehicle seat 1 comprising a backrest 2 attached to a seat base frame 21, 31, 41 and arranged to be rotatably adjustable around a first horizontal axis 11. The vehicle seat 1 further comprises a seat base 3 attached to the seat base frame 21, 31, 41 and arranged to be rotatably adjustable around a second horizontal axis 12 parallel to the first horizontal axis 11. A gear mechanism 20, 30, 40 is connected to the seat base frame 21 and is arranged to rotate the seat base frame 21, 31, 41 from a forward facing position to a backward facing position. The gear mechanism 20, 30, 40 comprises a track 22, 32, 42, and the seat base frame comprises a guide 23, 33, 43 that is configured to engage the track 22, 32, 42, such that when the gear mechanism is actuated, the seat base frame 21, 31, 41 is translated in a XY-plane and is rotated around a first vertical axis 13. The backrest 2 and the seat base 3, respectively, are arranged to be folded upwards during at least part of the rotation of the seat base frame 21, 31, 41 around the first vertical axis 13.

The gear mechanism 20, 30, 40 comprises a track 22, 32 and the seat base comprises a guide configured to run in the track such that when the gear mechanism 20 is actuated, the seat base frame 21, 31 translates in a XY-plane before, after and/or during rotation of the seat base frame 21, 31 around the first vertical axis 13.

With reference to FIGS. 4A-4F the backrest 2 and the seat base 3 are arranged to be folded upwards to a substantially vertical position during at least part of the rotation around the first vertical axis 13. The backrest 2 and the seat base 3 are arranged to be folded upwards during at least part of the rotation around the first vertical axis 13 to a position so as to be positioned within a cylindrical rotation volume 9 along the first vertical axis 13 with a circular cross section, the diameter of the circular cross-section being defined by the width of the seat base and/or the width of the backrest. FIG. 4F shows the gain in reduced space required when folding the seat base and backrest up as much as possible. In folded out seating position the vehicle seat use a lot more space in its facing direction.

With reference to FIGS. 2A-2C, the track 32 comprises a first translation track part 34 extending in a an X-direction perpendicular to a forward direction of the vehicle seat 1, a second translation track part 35 extending in a an X-direction perpendicular to a forward direction of the vehicle seat and an elliptical track part 36 connecting the first translation track part and the second translation track part. As shown in FIG. 4E the vehicle seat is translated in the XY-plane so that the center of the cylindrical rotation volume 9 is placed on the first vertical axis. This gear mechanism is used to rotate the backrest of the vehicle seat towards the side of the vehicle during rotation so as to move the center of rotation to the optimal position at vertical axis 13, as seen in FIG. 4F. The gear mechanism 30 comprises a cylinder gear 37 mounted on the vehicle floor. A motor is driving the cylinder gear and an elongated toothed engagement part 38 mounted on the seat base frame 31 extending linearly in a side direction of the vehicle seat. The elongated toothed engagement part 38 is in engagement with the cylinder gear 37.

With reference to FIGS. 1A and 1B the gear mechanism 20 comprises an elliptical internal ring gear 23 that is affixed to a vehicle body, and a cylinder gear 23 that is affixed to the seat base frame 21. The cylinder gear 23 is arranged inside the elliptical internal ring gear 22 such that rotation of the cylinder gear 23 causes it to travel along the circumference of the elliptical internal ring gear 22. The seat base frame 21 travels along both X and Y-directions during its rotation from forward facing to backward facing, and ends in the same XY-position after having been rotated. This is a further solution to translate the backrest of the vehicle seat towards the side of the vehicle during rotation so as to move the center of rotation closer to the optimal position at vertical axis 13, as seen in FIG. 4F.

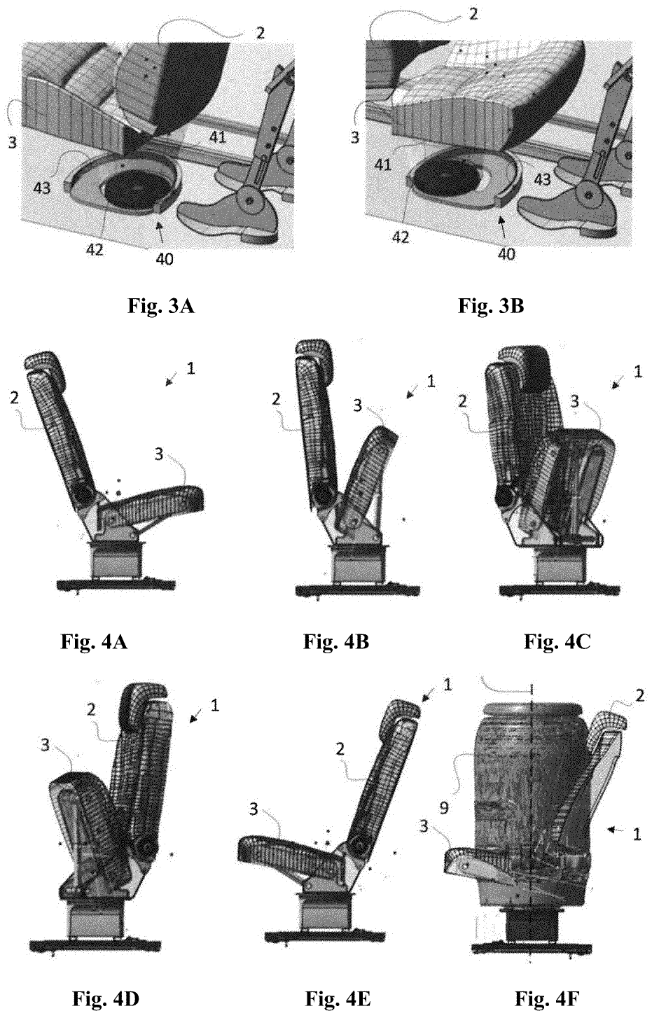

With reference to FIGS. 3A and 3B the gear mechanism comprises an internal semicircle gear 43 that is affixed to a vehicle body, and a cylinder gear 42 that is affixed to the seat base frame 41. The cylinder gear 42 is arranged inside the internal semicircle gear 43 such that rotation of the cylinder gear 42 causes it to travel along the circumference of the internal semicircle gear 43. The seat base frame 41 travels along both X- and Y-directions during its rotation from forward facing to backward facing, and ends in a different XY-position after having been rotated. This is a still further embodiment for translating the backrest of the vehicle seat towards the side of the vehicle during rotation so as to move the center of rotation closer to the optimal position at vertical axis 13, as seen in FIG. 4F.

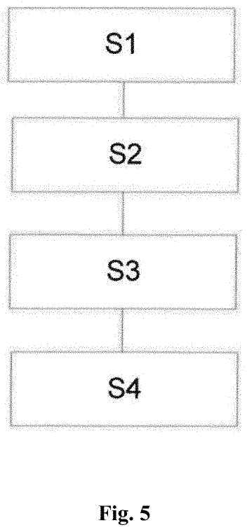

The second aspect of this disclosure is represented by FIG. 5 and shows a method for rotating a rotating vehicle seat according to the first aspect, the method comprising the steps of S1 translating the vehicle seat in the XY-plane, S2 rotating the vehicle seat 1, S3 folding seat base 3 upwards during the rotation of the seat base frame 21, 31, 41 around the first vertical axis 13. As previously described the translation in the horizontal XY-plane to the side of the vehicle will reduce the space required for the rotation as the vehicle seat.

The method further comprises the step of S4 folding the backrest 2 upwards during the rotation of the seat base frame 21, 31, 41 around the first vertical axis 13. The step of translating the seat bas frame 21, 31, 41 of the vehicle seat 1 in the XY-plane is made concurrent with the step of rotating the seat base frame 21, 31, 41.

The person skilled in the art realizes that the present invention is not limited to the preferred embodiments described above. The person skilled in the art further realizes that modifications and variations are possible within the scope of the appended claims. For example, further gear or cam solutions may be contemplated for achieving the translation in the horizontal plane before, after or during rotation of the seat base frame. Additionally, variations to the disclosed embodiments can be understood and effected by the skilled person in practicing the claimed invention, from a study of the drawings, the disclosure, and the appended claims.

What is claimed is:

1. A rotating vehicle seat comprising a backrest attached to a seat base frame and arranged to be rotably adjustable around a first horizontal axis,
a seat base attached to the seat base frame and arranged to be rotably adjustable around a second horizontal axis parallel to the first horizontal axis,
a gear mechanism connected to the seat base frame arranged to rotate the seat base frame from a forward facing position to a backward facing position,
wherein the gear mechanism comprises a track, and the seat base frame comprises a guide that is configured to engage the track, such that when the gear mechanism is actuated, the seat base frame is translated in a XY-plane, in both an X-direction and a Y-direction, and is rotated around a first vertical axis, and
wherein the backrest and the seat base, respectively, are arranged to be folded upwards during at least part of the rotation of the seat base frame around the first vertical axis.

2. The rotating vehicle seat according to claim 1, wherein the backrest and the seat base are arranged to be folded upwards to a substantially vertical position during at least part of the rotation around the first vertical axis.

3. The rotating vehicle seat according to claim 1, wherein the backrest and the seat base are arranged to be folded upwards during at least part of the rotation around the first vertical axis to a position so as to be positioned within a cylindrical rotation volume along the first vertical axis with a circular cross section, the diameter of the circular cross-section being defined by the width of the seat base and/or the width of the backrest.

4. The rotating vehicle seat according to claim 1, wherein the gear mechanism comprises a track and the seat base comprises a guide configured to run in the track such that when the gear mechanism is actuated, the seat base frame translates in a XY-plane before, after and/or during rotation of the seat base frame around the first vertical axis.

5. The rotating vehicle seat according to claim 4, wherein the track comprises:
a first translation track part extending in a an X-direction perpendicular to a forward direction of the vehicle seat,
a second translation track part extending in a an X-direction perpendicular to a forward direction of the vehicle seat.
an elliptical track part connecting the first translation track part and the second translation track part.

6. The rotating vehicle seat according to claim 4, wherein the gear mechanism comprises an cylinder gear mounted on the vehicle floor, a motor driving the cylinder gear and a an elongated toothed engagement part mounted on the seat base frame extending linearly in a side direction of the vehicle seat, the elongated toothed engagement part being in engagement with the cylinder gear.

7. The rotating vehicle seat according to claim 1, wherein the gear mechanism comprises an elliptical internal ring gear that is affixed to a vehicle body, and a cylinder gear that is affixed to the seat base frame, wherein the cylinder gear is arranged inside the elliptical internal ring gear such that rotation of the cylinder gear causes it to travel along the circumference of the elliptical internal ring gear, and the seat base frame travels along both X and Y-directions during its rotation from forward facing to backward facing, and ends in the same XY-position after having been rotated.

8. The rotating vehicle seat according to claim 1, wherein the gear mechanism comprises an internal semicircle gear that is affixed to a vehicle body, and a cylinder gear that is affixed to the seat base frame , wherein the cylinder gear is arranged inside the internal semicircle gear such that rotation of the cylinder gear causes it to travel along the circumference of the internal semicircle gear, and the seat base frame travels along both X and Y-directions during its rotation from forward facing to backward facing, and ends in a different XY-position after having been rotated.

9. The rotating vehicle seat according to claim 1, wherein the vehicle seat is translated in the XY-plane so that the centre of the cylindrical rotation volume is placed on the first vertical axis.

10. A method for rotating a rotating vehicle seat according to claim 1, the method comprising the steps of
translating the vehicle seat in the XY-plane,
rotating the vehicle seat folding seat base upwards during the rotation of the seat base frame around the first vertical axis.

11. The method according to claim 10, further comprising the step of
folding the backrest upwards during the rotation of the seat base frame around the first vertical axis.

12. The method according to claim 10, wherein the step of translating the seat bas frame of the vehicle seat in the XY-plane is made concurrent with the step of rotating the seat base frame.
